(19) United States
(12) Patent Application Publication
(10) Pub. No.: US 2007/0088937 A1
(43) Pub. Date: Apr. 19, 2007

(54) Computer-implemented method and processing unit for predicting branch target addresses

(75) Inventors: Roch G. Archambault, North York (CA); R. William Hay, Toronto (CA); James L. McInnes, Toronto (CA); Kevin A. Stoodley, Richmond Hill (CA)

Correspondence Address: HOFFMAN, WARNICK & D'ALESSANDRO LLC, 75 STATE ST, 14TH FLOOR, ALBANY, NY, 12207, US

(73) Assignee: INTERNATIONAL BUSINESS MACHINES CORPORATION, ARMONK, NY (US)

(21) Appl. No.: 11/250,057

(22) Filed: Oct. 13, 2005

(51) Int. Cl. G06F 9/00

(52) U.S. Cl. 712/239

(57) ABSTRACT

Under the present invention, a branch target address corresponding to a target instruction to be pre-fetched is predicted based on two values. The first value is a “predictor value” that is known for the branch target address. The second value is the address of the branch instruction from which the target instruction is branched to within the program code. Once these two values are provided, they can be processed (e.g., hashed) to yield an index value, which is used to obtain a predicted branch target address from a cache. This technique is generally implemented for branch instructions such as switch statements or polymorphic calls. In the case of the former, the predictor value is a selector operand, while in the case of the latter the predictor value is a class object address (in JAVA) or a virtual function table address (in C++).

### BACKGROUND OF THE INVENTION

1. Field of the Invention

In general, the present invention relates to instruction address prediction. Specifically, the present invention relates to a computer-implemented method and processing unit for predicting branch target addresses

2. Related Art

Current central processing unit (CPU) designs have branch prediction mechanisms (i.e., for instructions) that are poorly designed for predicting branches associated with two important types of code, namely switch statements and polymorphic calls. This is mainly because current designs use the location of the branch instruction within the program code to predict the destination/target of the branch, which does not work well in general for switches and (truly) polymorphic calls as well as other common source language constructs. One attempt to solve this problem is to process bits of the computed target of the branch in order to disambiguate the actual destination from other destinations previously branched to from that location. Unfortunately, one of the problems with this solution is that it is very difficult to obtain the target address far enough ahead of executing the branch instruction so that the destination instructions can be fetched soon enough to avoid a bubble in execution. In addition, if the incorrect instruction is predicted and then pre-fetched, a penalty when the true target address is discovered may result. Another heuristic technique has used an approximation of the code path executed to reach the branch instruction to try to support and disambiguate multiple predicted targets for that branch. Unfortunately, the correspondence between those values (path and target) is weak in practice.

High branch mis-prediction rates on object-oriented codes (such as Websphere Application Server) and programs containing switch statements (e.g. perlBMK in specINT2000) lead to poor performance of those codes on existing PowerPC processor implementations These processors use a simple cache to predict targets for indirect branches through a count register. This mechanism simply does not work well for switch statements or polymorphic calls. For the subset of switches and polymorphic calls which have a single target (which would appear to be well predicted by a simple count cache implementation), there are compilation techniques (i.e., transforming the switch statement to have an explicit test for the common case or de-virtualizing monomorphic and pseudo monomorphic calls) based on profile or type system analysis that eliminate these from the code the CPU executes. Thus, in practice, the machine's mechanisms for predicting indirect branches fail to work for switch statements or polymorphic call types of branch instructions. In addition, the effectiveness of the count cache implementation on inter-module calls is reduced due to pollution of the (fixed size) cache with entries trying (but failing) to predict switch statements and polymorphic calls. Furthermore, due to the increased use of object oriented programming techniques and interpreted languages, the number of polymorphic calls and switch statements executed by modern processors is also increasing. Finally, as processors become more heavily pipelined, the penalty paid for an incorrectly predicted branch is also increasing. In programs such as Websphere Application Server, for example, prediction rates as low as 40% have been measured on the count register cache. Capacity in the count cache alone cannot solve this problem as at most it ameliorates the pollution effect described above and does not improve the fundamental issues that are reducing performance.

In view of the foregoing, there exists a need for a solution that addresses the above-discussed deficiencies in the related art.

### SUMMARY OF THE INVENTION

In general, the present invention relates to a computer-implemented method and processing unit for predicting branch target addresses. Specifically, under the present invention, a branch target address corresponding to a target instruction to be pre-fetched is predicted based on two values. The first value is a “predictor value” that is known for the branch target address. The second value is the address of the branch instruction the target of which is being predicted. Once these two values are provided, they can be combined (e.g., hashed) to yield an index value, which is used to obtain a predicted branch target address from a cache. This technique is generally implemented for branch instructions that are used to implement switch statements or polymorphic calls. In the case of a switch statement, the predictor value can be a selector operand, while in the case of a polymorphic call, the predictor value can be a class object address (e.g., in JAVA) or a virtual function table address (e.g., in C++).

It should be understood, however, that this technique can be used wherever correct target address prediction is enhanced by identifying a predictor value to the CPU. For example, another source language construct for which the present invention can be utilized is a call through an element in an array of function pointers. This construct would use the bcctrl instruction (from the PowerPC instruction set) similar to polymorphic calls although with a different address computation more like that used for switch statements. Specifically, in this case, the array index would be used as the predictor value.

A first aspect of the present invention provides a computer-implemented method for predicting branch target addresses, comprising: obtaining a predictor value known for a branch target address corresponding to a target instruction to be pre-fetched; determining an address of a branch instruction within program code; and predicting the branch target address using the predictor value and the address of the branch instruction.

A second aspect of the present invention provides a processing unit for predicting branch target addresses, comprising: means for obtaining a predictor value known for a branch target address corresponding to a target instruction to be pre-fetched; means for determining an address of a branch instruction within program code; and means for predicting the branch target address using the predictor value and the address of the branch instruction.

A third aspect of the present invention provides a processing unit for predicting branch target addresses, comprising: means for obtaining a predictor value known for a branch target address corresponding to a target instruction to be pre-fetched; means for determining an address of a branch instruction within program code; means for hashing the predictor value with the address of the branch instruction to yield an index value; and means for obtaining the branch target address from a cache using the index value.

Therefore, the present invention provides a computer-implemented method and processing unit for predicting branch target addresses.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts a system for predicting target branch addresses according to the present invention.

FIG. 2 depicts a flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes the Detailed Description of the Invention will have the following sections:
I. General Description
II. Typical Embodiment
III. Computerized Implementation
   I. General Description

As indicated above, the present invention relates to a computer-implemented method and processing unit for predicting branch target addresses. Specifically, under the present invention, a branch target address corresponding to a target instruction to be pre-fetched is predicted based on two values. The first value is a “predictor value” that is known for the branch target address. The second value is the address of the branch instruction the target of which is being predicted. Once these two values are provided, they can be combined (e.g., hashed) to yield an index value, which is used to obtain a predicted branch target address from a cache. This technique is generally implemented for branch instructions that are used to implement switch statements or polymorphic calls. In the case of a switch statement, the predictor value can be a selector operand, while in the case of a polymorphic call, the predictor value can be a class object address (e.g., in JAVA) or a virtual function table address (e.g., in C++).

It should be understood, however, that this technique can be used wherever correct target address prediction is enhanced by identifying a predictor value to the CPU. For example, another source language construct for which the present invention can be utilized is a call through an element in an array of function pointers. This would use the bcctrl instruction (from the PowerPC instruction set) similar to polymorphic calls although with a different address computation more like that used for switch statements. In this case, the array index would be used as the predictor value.

In one embodiment, the suggested mechanism for PowerPC would have the portion of the address computation stored in, for example, R12. This embodiment can utilize particular encoding set in the branch and link through the count register instruction (the bcctrl instruction is typically used to implement polymorphic call, while the bcctr instruction is typically used for switch statements) to indicate to the CPU that it is to use the value in R12 as part of its prediction logic. In addition, this embodiment uses a convention between the compiler or programmer whereby both parties agree to use a particular register, in this example R12, to convey the predictor value to the CPU as it executes the code. It should be understood that R12 is specifically set forth herein for illustrative purposes only, and that other register locations could be used. In another more typical embodiment, an explicit instruction provided in the CPU instruction set would be emitted by the compiler or programmer for the purpose of obtaining the predictor value for the target instruction

II. Typical Embodiment

As indicated above, the present invention will predict branch target addresses for certain types of branch instructions, namely, those arising from the implementation of switch statements and polymorphic calls. In a typical embodiment of the present invention, two values are used to form an index value, which will then be used to obtain the desired branch target address from a cache. The first value is a known predictor value for the branch target address, and the second value is the address of the branch instruction itself within the program code.

The real predictor value for these two types of branch instructions is not simply the address of the branch instruction as is often used in simple caching branch target prediction mechanisms currently in use. Rather, in the case of a polymorphic call, the predictor value is the address of the class object (Java) or Virtual Function Table (C++). For a switch statement, it is the selector operand that is used to index into the branch table that underlies the implementation of switches that use a count register. In each of these scenarios (switch and polymorphic call), the final branch target address is loaded from a memory location whose address is the sum of two terms. In each case, one of the terms of this sum is the predictor value, or is a simple arithmetic operation performed on the predictor value, such as the predictor value multiplied by “8.”

Under a typical embodiment of the present invention, the compiler is modified to emit a branch prediction hint instruction identifying the predictor value to the CPU by means of a register operand contained in the branch prediction instruction. The value in the designated register is held in the internal state (such as an internal register) of the processor in preparation for being combined with the address of the branch instruction whose target is to be predicted. When predicting a branch target address for a bcctr or bcctrl instruction, the presence of the predictor value in the internal state indicates that it is to use branch prediction as described by this invention rather than a simple target cache sufficient to correctly predict intra-module calls or other single destination indirect branch sources. The compiler (or assembly language programmer) is thus able to direct the CPU as to which branch target prediction scheme will work best for a particular branch.

To support the prediction of branch target addresses in this invention, a cache (or hash table) of target addresses is kept. This cache is indexed by hashing bits from the predictor value held in internal state (whose source was a branch prediction hint instruction) with the address of the branch instruction itself (i.e., the address of the branch instruction within the actual program code). That is, the predictor value is hashed with the address of the branch instruction to yield an “index” value, which is then used to obtain the branch target address from the cache. The branch target address is returned from the lookup and the machine then uses that address to fetch instructions (and potentially speculatively execute depending on the capabilities of the chip to execute speculatively) in advance of definitive determination of the actual branch target when the branch instruction is actually executed. When the branch is actually executed, the internal state (e.g., internal register) that held the predictor value is cleared. It should be cleared or otherwise invalidated so that subsequent branch instructions which do not have a predictor value will not incorrectly use the predictor value meant for a previously executed branch instruction.

Various options are possible if the lookup fails (finds an invalid address). The machine could stall, or try some other predictor mechanism. When the lookup fails entirely or fails to predict the branch correctly then the correct target address computed in the execution of the branch instruction can be added to the cache using the hashed value to index in the same way as it would be used to do a lookup. The replacement policy and arrangement of the cache can be based off any number of design points. Ideally, the cache would be able to handle many targets for one branch instruction or few targets for a larger number of branch instructions.

By using the presence of the branch predictor value in internal state (or in the case of the alternate embodiment, a particular encoding of an instruction such as a bit on the affected branch instructions) to determine whether or not to hash bits from the predictor value with the address of the branch instruction, a combined cache implementation could also be devised to allow one hardware cache to satisfy these types of indirect branch scenarios. Of course, in order to handle it just as well as two structures, the single structure would have to be larger, but perhaps not as large as the combined size of the two caches. In the case where a single cache structure is used for both, then a different hash lookup function would be used for predicting intra-module call instruction which only uses bits from the address of the branch and link instruction

In the preferred implementation, an instruction would be added to CPU's instruction set that would take a single general purpose register operand. This instruction would be an explicit branch target hint for a data-dependent branch target where the register would be the predictor value discussed above. The advantages of this implementation would be that any general purpose register could be used, that the register could then be reused subsequent to the branch instruction without danger of affecting the quality of prediction and that a simple binary post processor would be able to enhance an existing binary to use this technique with minimal disruption to the binary executable program. This technique is equally applicable to processors which implement indirect branch differently than PowerPC such as IBM's z processor family, or x86, or x86-64.

Listed below is exemplary code for the present invention:

```
int foo (unsigned s)
{
  int a,b,c;
  switch (s)
  {
  case (0): a = 4; break;
  case (1): a = 3; break;
  case (2): a = 2; break;
  case (3): a = 1; break;
  case (4): a = 0; break;
  case (5): a = 10; break;
  case (6): a = 100; break;
  case (7): a = 200; break;
  case (8): a = 300; break;
  case (9): a = 400; break;
  case (10): a = 500; break;
  }
  return (a);
}
```

Below is what was produced before implementing the invention for the computation of the target address (in this case a 32-bit environment, although the invention applies equally well to addresses of any size):

.foo:

| cmpli 0,0,r3,0x000a | # check for too big |
|---|---|
| lwz r5,T.18._STATIC(RTOC) | # load base address of |
| | initialised static |
| rlwinm r4,r3,2,26,29 | # multiply selectore by 4 |

| lwzx r3,r5,r4 | # load target address from |
|---|---|
| | initialised table |
| bgt _L70 | # branch around BCCTR if |
| | selectore out of range |
| mtspr CTR,r3 | # move target address to CTR |
| bcctr | # branch indirect thrugh CTR |

_L70: <bad selector>

Using the method of adding an explicit instruction to identify the prediction register, below is exemplary code under a typical embodiment of the present invention

.foo:

| | |
|---|---|
| cmpli 0,0,r3,0x000a | # check for too big |

| | |
|---|---|
| predctr r3 | # indicate where the |

predictor for the

upcoming branch can be found

| lwz r5,T.18._STATIC(RTOC) | # load base address of |
|---|---|
| | initialised static |
| rlwinm r4,r3,2,26,29 | # multiply selector by 4 |

| lwzx r3,r5,r4 | # load target address from |
|---|---|
| | initialised table |
| bgt _L70 | # branch around BCCTR if |
| | selector out of range |
| mtspr CTR,r3 | # move target address to CTR |
| bcctr | # branch indirect thrugh CTR |

__L70: <bad selector>

III. Computerized Implementation

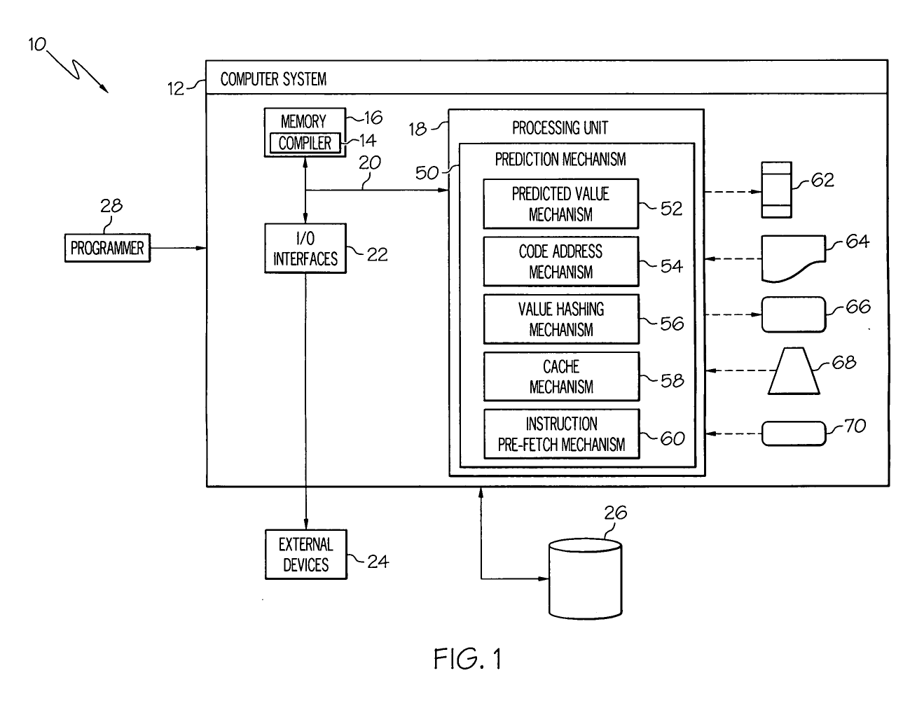

Referring now to FIG. 1, a more specific computerized implementation 10 of the present invention is shown. As depicted, implementation 10 includes a computer system 12. It should be understood that computer system 12 is intended to represent any type of computer system capable of carrying out prediction of a branch target address in accordance with the present invention.

As shown, computer system 14 includes a memory 16, a processing unit 18, a bus 20, and input/output (I/O) interfaces 22. Further, computer system 12 is shown in communication with external I/O devices/resources 24 and storage system 26. As known in the art, processing unit 18 executes computer program code, which is stored in memory 16 and/or storage system 26. While executing computer program code, processing unit 18 can read and/or write data to/from memory 16, storage system 26, and/or I/O interfaces 22. Bus 20 provides a communication link between each of the components in computer system 12. External devices 24 can comprise any devices (e.g., keyboard, pointing device, display, etc.) that enable a user to interact with computer system 12 and/or any devices (e.g., network card, modem, etc.) that enable computer system 12 to communicate with one or more other computing devices.

Computer system 12 is only representative of various possible computer systems that can include numerous combinations of hardware. To this extent, in other embodiments, computer system 12 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 18 may comprise a single processing unit, or be distributed across one or more processing units in one or more locations, e.g., on a client and server. Similarly, memory 16 and/or storage system 26 can comprise any combination of various types of data storage and/or transmission media that reside at one or more physical locations. Further, I/O interfaces 22 can comprise any system for exchanging information with one or more external devices 24. Still further, it is understood that one or more additional components (e.g., system software, math co-processing unit, etc.) not shown in FIG. 1 can be included in computer system 12. However, if computer system 12 comprises a handheld device or the like, it is understood that one or more external devices 24 (e.g., a display) and/or storage system(s) 26 could be contained within computer system 12, not externally as shown.

Storage system 26 can be any type of system (e.g., a database) capable of providing storage for information under the present invention such as values, instructions, etc. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown within in processing unit 18 of computer system 12 is prediction mechanism 50, which is a hardware implementation (micro architecture) that will provide the functions of the present invention, and which includes predicted value mechanism 52, code address mechanism 54, value hashing mechanism 56, cache mechanism 58, and instruction pre-fetch mechanism 60. In general, these mechanisms provide/enable the functions of the present invention as described above. Specifically, assume that a branch target address is desired to be predicted. Predicted value mechanism 52 will first obtain a predictor value known for the branch target address corresponding to a target instruction to be pre-fetched. As indicated above, this predictor value can be obtained in any number of ways such as from compiler 14, programmer 28, etc. For example, the predictor value can be provided via a convention between compiler 14 or programmer 28 and processing unit 18, or via an explicit instruction provided by compiler 14 or programmer 18. In the case of a polymorphic call type of branch instruction, the predictor value can be the address of the class object (Java) or Virtual Function Table (C++). For a switch statement type of branch instruction, the predictor value can be the selector operand that is used to index into the branch table that underlies the implementation of switches that utilize a count register.

Regardless, once the predictor value is known, it will be stored (e.g., an internal register 62). Thereafter, code address mechanism 54 will analyze the set of program code 64 containing the branch instruction, and determine the address of the branch instruction within the program code 64. Value hashing mechanism 56 will then hash the predictor value with the address of the branch instruction to yield an index value 66. Once the index value 66 is provided, cache mechanism 58 will use index value 66 to locate and retrieve the branch target address 70 from cache 68. Once retrieved, the branch target address 70 will be used by instruction pre-fetch mechanism 60 to pre-fetch the desired instruction. In the event that the branch target address is incorrect (i.e., results in a pre-fetching of a different instruction than was desired), cache mechanism 58 will update cache 68 accordingly). It should be understood that one or more of the components 62, 64, 66, 68, and/or 70 shown in FIG. 1 could exist within processing unit 16, memory 18, storage system 26, etc. They all have been shown communicating with processing unit 16 in dashed line format for the purposes of more clearly describing the functions of the present invention.

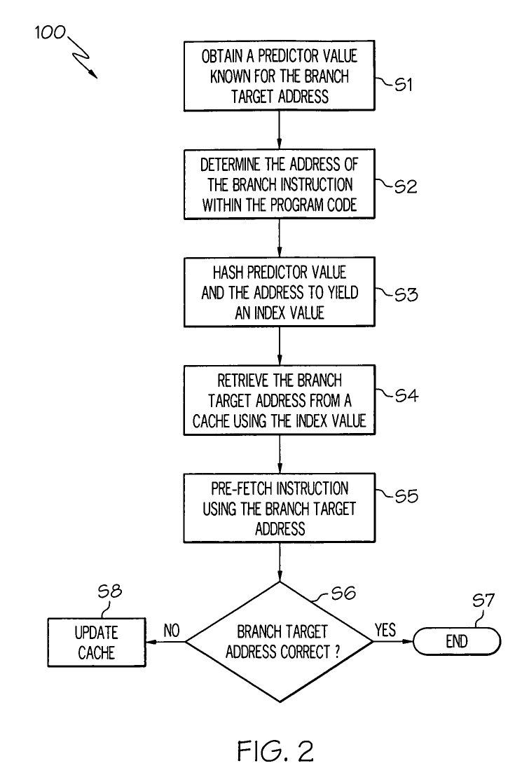

Referring now to FIG. 2, a method flow diagram 100 summarizing the above will be shown and described. As shown, first step S1 is to obtain a predictor value known for the branch target address. As described above, this can depend on the type of branch instruction (e.g., polymorphic versus switch statement) and/or the programming language (e.g., JAVA versus C++). Moreover, in a typical embodiment, the predictor value is obtained from (e.g., an explicit instruction provided by) a compiler or a programmer. Once the predictor value is obtained, the address of the branch instruction within the program code will be determined in step S2. These two values will then be hashed in step S3 to yield an index value, which is used to locate and retrieve the branch target address from a cache in step S4. Then in step S5, the branch target address is used to pre-fetch the desired instruction. In step S6, it is determined whether the branch target instruction was correct. That is, it is determined whether the branch target address resulted in the correct/desired instruction to be pre-fetched. If so, the process can end in step S7 (or repeat to pre-fetch another instruction). However, if the branch target instruction retrieved from the cache was incorrect, the cache will be updated accordingly in step S8. The present invention should be understood to provide all functionality discussed herein, although such functionality may not be shown in FIG. 2 for brevity purposes.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for predicting branch target addresses, comprising:
obtaining a predictor value known for a branch target address corresponding to a target instruction to be pre-fetched;
determining an address of a branch instruction within program code; and
predicting the branch target address using the predictor value and the address of the branch instruction.

2. The computer-implemented method of claim 1, further comprising:
storing the predictor value in an internal register;
hashing the predictor value with the address of the branch instruction to yield an index value; and
obtaining the branch target address from a cache of branch target addresses using the index value.

3. The computer-implemented method of claim 2, further comprising updating the cache if the branch target address is incorrect for the target instruction.

4. The computer-implemented method of claim 1, wherein the target instruction is predicted, pre-fetched and branched to from the branch instruction.

5. The computer-implemented method of claim 1, wherein the branch instruction comprises a switch statement, and wherein the predictor value is a selector operand.

6. The computer-implemented method of claim 1, wherein the branch instruction comprises a polymorphic call, and wherein the predictor value is selected from the group consisting of a class object address and a virtual function table address.

7. The computer-implemented method of claim 1, wherein the branch instruction comprises a call through an element in an array of function pointers, and wherein the predictor value is an array index.

8. The computer implemented method of claim 1, wherein obtaining the predictor value comprises receiving the predictor value from a compiler.

9. The computer implemented method of claim 1, wherein the obtaining comprises receiving the predictor value from a programmer.

10. A processing unit for predicting branch target addresses, comprising:
means for obtaining a predictor value known for a branch target address corresponding to a target instruction to be pre-fetched;
means for determining an address of a branch instruction within program code; and
means for predicting the branch target address using the predictor value and the address of the branch instruction.

11. The processing unit of claim 10, further comprising:
means for storing the predictor value in an internal register;
means for hashing the predictor value with the address of the branch instruction to yield an index value; and
means for obtaining the branch target address from a cache of branch target addresses using the index value.

12. The processing unit of claim 11, further comprising means for updating the cache if the branch target address is incorrect for the target instruction.

13. The processing unit of claim 10, wherein the target instruction is predicted, pre-fetched and branched to from the branch instruction.

14. The processing unit of claim 10, wherein the branch instruction comprises a switch statement, and wherein the predictor value is a selector operand.

15. The processing unit of claim 10, wherein the branch instruction comprises a polymorphic call, and wherein the predictor value is selected from the group consisting of a class object address and a virtual function table address.

16. The processing unit of claim 10, wherein the branch instruction comprises a call through an element in an array of function pointers, and wherein the predictor value is an array index.

17. The processing unit of claim 10, wherein means for obtaining the predictor value receives the predictor value from a compiler.

18. The processing unit of claim 10, wherein the means for obtaining receives the predictor value from a programmer.

19. A processing unit for predicting branch target addresses, comprising:
means for obtaining a predictor value known for a branch target address corresponding to a target instruction to be pre-fetched;
means for determining an address of a branch instruction within program code;
means for hashing the predictor value with the address of the branch instruction to yield an index value; and
means for obtaining the branch target address from a cache using the index value.

20. The processing unit of claim 19, wherein the predictor value is stored in an internal register.

21. The processing unit of claim 19, further comprising means for updating the cache if the branch target address is incorrect for the instruction.

22. The processing unit of claim 19, wherein the target instruction is predicted, pre-fetched and branched to from the branch instruction.
